(19) United States
(12) Patent Application Publication
(10) Pub. No.: US 2003/0205930 A1
(43) Pub. Date: Nov. 6, 2003

(54) High idle creep control by brake-by-wire braking

(75) Inventor: Thomas Allen Smart, Franklin, MI (US)

Correspondence Address: DYKEMA GOSSETT PLLC, 39577 WOODWARD AVENUE, SUITE 300, BLOOMFIELD HILLS, MI, 48304, US

(73) Assignee: Ford Global Technologies, Inc., Dearborn, MI (US)

(21) Appl. No.: 10/063,632

(22) Filed: May 6, 2002

(51) Int. Cl. B60T 13/66

(52) U.S. Cl. 303/20

(57) ABSTRACT

A method and system for controlling high idle creep through brake-by-wire braking is disclosed for a vehicle (10) having an engine (12) operable at a first idle speed and at a second faster idle speed. The method (44) includes the steps of determining whether the engine is operating at the second idle speed (48), and friction braking (50) a wheel (16) through a brake-by-wire system (30) to offset additional torque provided to the wheel (16) by the engine (12) operating at the second idle speed. The system includes a braking device (36) for braking a wheel (16) in response to a braking signal (38) and a controller (34) for generating a braking signal to offset additional power provided to the wheel (16) by the engine (12) operating at the second idle speed.

### BACKGROUND OF INVENTION

The present invention relates to a system and method for controlling vehicle creep through brake-by-wire braking during high idle conditions.

It is often desirable to operate a vehicle engine at an idle speed faster than a regular idle speed. For example, in starting a hybrid electric vehicle (HEV) from an initial cold start, it may be desirable to operate the internal combustion engine at an idle speed faster than the regular idle speed in order to recharge the high voltage traction battery more quickly. It may be further desirable to operate the internal combustion engine of both conventional vehicles and HEVs at a faster idle speed following an initial cold start in order to provide heat more quickly to a vehicle cabin heater or to the catalyst of an emissions control system.

In addition, there are further circumstances during which it may be desirable to operate the engine at a faster idle speed. For example, a faster idle speed may be desired during low speed conditions in a vehicle with an engine-driven power steering pump. In such a vehicle, greater steering power, i.e. greater pumping action, may be required when a vehicle operator fully turns the steering wheel from a lock to lock position. A faster idle speed may also be desired when operating an air conditioning system for which the air conditioning compressor is coupled to the engine. Furthermore, a faster idle speed may be desired to increase coolant flow to a radiator or heater core when using an engine-driven coolant pump.

One difficulty, however, with operating a vehicle engine at a higher idle speed is the effect on vehicle creep speed. Vehicles with automatic transmissions advantageously provide creep the tendency of the vehicle to move slowly in forward or reverse when either gear is engaged and the engine is at idle. An engine that operates at a faster idle speed produces faster vehicle creep. Vehicle operators may find faster creep to be undesirable, as it requires additional force on the brake pedal to resist this creep and hold the vehicle at rest.

Prior art strategies often relate to suppressing or eliminating creep under certain circumstances. Other prior art strategies relate to controlling vehicle speed with a brake-by-wire system, such as U.S. Pat. No. 6,122,588 to Shehan et al., commonly assigned, the disclosure of which is incorporated by reference herein. However, neither of these approaches sufficiently control creep to a familiar level during high idle conditions.

### SUMMARY OF INVENTION

A method and system for controlling high idle creep through brake-by-wire braking is provided. The invention discloses a method for controlling creep in a vehicle having both a brake-by-wire system for braking a wheel independent of a braking action demanded by a vehicle operator, and an internal combustion engine for powering a wheel and for powering a load. The vehicle engine is operable at a first idle speed and a second faster idle speed. The method includes the steps of determining whether the engine is operating at the second idle speed, and then applying friction braking to one or more wheels through the brake-by-wire system to offset additional torque provided to the wheels by the engine at the second idle speed.

The invention also discloses a creep control system for a vehicle having an internal combustion engine which powers a wheel and a load. The engine is operable at a first idle speed and a second faster idle speed. The load may draw mechanical power or thermal energy from the engine. The creep control system includes a braking device for braking a wheel in response to a braking signal, and a controller generating a braking signal to offset additional power provided to the wheel by the engine at the second idle speed.

The invention is applicable to hybrid electric vehicles and vehicles solely powered by internal combustion engines.

An advantage of the present invention is that it provides a method for controlling creep of a hybrid electric vehicle during high idle conditions. A further advantage of this invention is that it provides a method for controlling creep of a conventional vehicle during high idle conditions.

An additional advantage of this invention is that it provides a creep control system for a vehicle having a first idle speed and a second, faster idle speed. Another advantage of this invention is that it provides an automobile that controls creep during high idle conditions.

The above advantages and other advantages, objects, and features of the present invention will be readily apparent from the following detailed description of the invention and accompanying drawings.

### BRIEF DESCRIPTION OF DRAWINGS

FIG. 1 is a block diagram of a vehicle according to the present invention.

FIG. 2 is a flow diagram of a method for controlling high idle creep by brake-by-wire braking in the vehicle of FIG. 1 according to the present invention.

### DETAILED DESCRIPTION

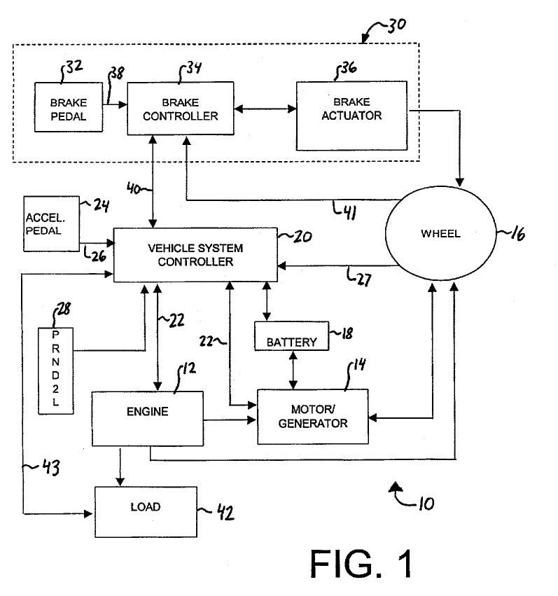

Referring now to the drawings wherein like reference numerals are used to identify similar components in the various embodiments, FIG. 1 shows a block diagram of a vehicle 10 having a system for high idle creep control by brake-by-wire braking according to the present invention. The vehicle 10 is a hybrid electric vehicle, powered by an engine 12, an electric motor/generator 14, or both. The engine 12 is a reciprocating piston internal combustion engine, well known in the art. The engine 12 provides power to a wheel 16. It will be appreciated by those skilled in the art that the engine 12 can power the wheel 16 through a powertrain including a transmission (not shown) and a differential (not shown), and that the wheel 16 can be one of a plurality of wheels powered by the engine 12.

The motor/generator 14 is operable as an electric motor or an electric generator. It will be appreciated by those skilled in the art that motor/generator 14 could also be two separate electric machines providing each of these functions. The motor/generator 14 can drive the wheel 16 independent of or in combination with the engine 12. The motor/generator 14 can also be powered by the engine 12 to generate electricity. The motor/generator 14 supplies a charge to a traction battery 18. Therefore, the motor/generator 14 can receive power or voltage from the battery 18 to provide power to the wheel 16.

Additionally, the motor/generator 14 can cooperate with the wheel 16 to provide a regenerative braking system to convert kinetic energy of the vehicle 10 into electricity. Such a regenerative braking system is operable to regenerate kinetic energy that a conventional vehicle 10 dissipates during braking, or any other period during which the accelerator pedal is not depressed while the vehicle is in motion, e.g. coasting. The kinetic energy received during this process can be used to recharge the battery 18 and is stored for future use.

It will be appreciated by those skilled in the art that the vehicle 10 can also represent a conventional vehicle powered solely by the engine 12 without the motor/generator 14.

The engine 12 and the motor/generator 14 are in communication with a vehicle system controller 20 via appropriate communication links 22. The vehicle system controller 20 comprises microprocessor-based controllers (not shown) with associated microprocessors (not shown) that communicate with associated computer-readable storage media (not shown). Communication links 22 preferably conform to an intra-controller bus standard, but are at least capable of exchanging information and commands relative to current operating conditions and control of the vehicle 10.

The vehicle system controller 20 also includes appropriate electronic circuitry, integrated circuits, and the like to effect control of the engine 12 and the motor/generator 14. As such, the vehicle system controller 20 is used to effect control logic implemented in terms of software (instructions) and/or hardware components, depending upon the particular application. It will be appreciated by those skilled in the art that the vehicle system controller 20, as shown in FIG. 1, can comprise one or more controllers in communication with the engine 12, the motor/generator 14, and other vehicle components.

The vehicle system controller 20 can also be in communication with an accelerator pedal 24. The vehicle system controller 20 can receive a signal 26 indicative of the position of the accelerator pedal 24. The position of the accelerator pedal 24 is input by a vehicle operator, and indicates the vehicle operator's demand for torque at the wheel 16. The accelerator pedal signal 26 is processed by the vehicle system controller 20 to generate a corresponding request for additional power from the engine 12 or the motor/generator 14. The vehicle system controller 20 is also cognizant of the velocity of the vehicle 10, such as by receiving a wheel velocity signal 27 from the wheel 16.

The vehicle system controller 20 is also in communication with the gear selection 28 of the vehicle operator. Vehicle system controller is cognizant of whether the vehicle operator has selected the transmission to be in park, reverse, neutral, drive, second, or low gear.

The vehicle 10 includes a brake-by-wire system 30 for friction braking the wheel 16 in response to a braking action demanded by a vehicle operator. The brake-by-wire system 30 is known in the art, and can include a brake pedal 32, a brake controller 34, a frictional brake actuator 36, and a foundation brake (not shown) which is moved by the brake actuator 36. The brake-by-wire system 30 can comprise an electric brake system or an electro-hydraulic brake system. An electric brake system can include only electrical connections between the components of the system. An electro-hydraulic brake system can include hydraulic or pneumatic, and electrical connections between the various components of the system. This brake-by-wire system 30 also has the capability to friction brake the wheel 16 in response to the brake controller 34, independent of a driver input to the brake pedal 32.

The brake controller 34 can receive a signal 38 or message indicative of the position of the brake pedal 32, the rate of application, or both. The brake pedal input is processed by the brake controller 34 to generate a corresponding braking request depending upon the particular operating conditions of the vehicle. The brake controller 34 communicates with the vehicle system controller 20 to determine how much of the braking request can be met by regeneration from the motor/generator 14. The remainder of the braking request is transmitted to the brake actuator 36 which applies hydraulic/pneumatic or electric signals to the braking device(s) to effect friction braking of the vehicle. Typically, there is no direct mechanical or fluid coupling between the brake pedal controlled by the operator and the actual braking devices. As such, the braking controller can determine an appropriate amount of braking torque to be applied to the wheel 16 based upon the current operating conditions.

The brake controller 34 can be in communication with the vehicle system controller 20 through an appropriate communication link 40. Communication link 40 preferably conforms to an intra-controller bus standard, but is at least capable of exchanging information and commands relative to current operating conditions and control of the vehicle 10. The brake controller 34 can also be integrated with the vehicle system controller 20.

The brake controller 34 processes the signals received from various sensors and messages from the vehicle system controller 20, which can include appropriate requests for system braking to generate a continuously variable braking torque. The brake controller 34 can also include various other braking functions and provide appropriate signals such as an anti-lock braking (ABS) or vehicle stability control (VSC) control signal. Such ABS and VSC signals may be based on, among other factors, the velocity of the wheel 16. The velocity of the wheel 16 may be determined by a wheel speed sensor (not shown), which transmits the signal 27 to the vehicle system controller 20. Alternatively, the wheel speed sensor may transmit a signal 41 to the brake controller 34.

Although the engine 12, the motor/generator 14, and the brake-by-wire system 30 each cooperate with the wheel 16 of the vehicle 10 as shown in this embodiment, it will be appreciated by those skilled in the art that the engine 12, the motor/generator 14, and the brake-by-wire system 30 can alternatively cooperate with one or more different wheels of the vehicle 10.

The engine 12 is operable at a first idle speed and a second faster idle speed. The first idle speed may be at speeds of, for example, 550 to 800 rpm. The second idle speed may be at speeds of, for example, 900 to 1600 rpm. Additionally, the engine 12 powers a load 42. The engine 12 operates at the first idle speed under most operating conditions. The engine 12 can operate at the second faster idle speed when powering the load 42.

The load 42 receives power from the engine 12. The output torque of the engine 12 drives mechanical loads. Loads receiving mechanical power from the engine 12 can include an air conditioning compressor, a power steering pump, a coolant pump, and/or an alternator. Additionally, the load 42 can comprise powering the motor/generator 14 to charge the battery 18.

Alternatively, the engine 12 can provide thermal energy to the load 42. The resultant heat energy provided by the combustion occurring within the engine 12 provides thermal energy to such thermal loads. Loads receiving thermal energy from the engine 12 can include an emissions control system, such as a catalytic converter, or a heat exchanger used to heat the interior of the vehicle 10.

The load 42 is in communication with the vehicle system controller 20 through communication link 43. The condition of the load 42 can determine whether the engine 12 is operable at the first idle speed, or at the second idle speed. For example, upon a cold start it may be desirable to heat thermal loads quickly. Accordingly, the vehicle system controller 20 can signal the engine 12 to operate at the second idle speed until the temperature of the engine 12 and of the emission controls system has reached a predetermined level. Similarly, it may be desirable to operate the engine 12 to charge the battery 18, by powering the motor/generator 14. Accordingly, the vehicle system controller 20 can signal the engine 12 to operate at the second idle speed until the battery 1 8 has reached a sufficient charge state. Further, it may be desirable to operate the engine 12 at the second idle speed to drive a steering wheel pump at a faster rate, typically to provide greater power steering assist at low or idle speeds, or other conditions dependent on the velocity of the vehicle 10.

Notwithstanding the desirability of operating the engine 12 at the second idle speed, the second idle speed necessarily increases the power from the engine 12 to the wheel 16. Left unabated, this additional power results in increased creep of the vehicle 10 at idle speeds. However, the inventive vehicle 10 is provided to control high idle creep through the brake-by-wire system 30.

The brake controller 34 is in communication with the vehicle system controller 20 as described above. The vehicle system controller 20 signals the brake controller 34 when the engine 12 is operating at the second idle speed. In response, the brake controller 34 generates a braking signal, independent of vehicle operator input, to the brake actuator 36 to offset the additional power, above that which would be produced by the engine 12 operating at the first idle speed. The vehicle system controller 20 further communicates to the brake controller 34 whether the engine 12 is providing torque to the wheel 16; that is, whether the vehicle operator has selected either reverse, drive, second, or low gear. Additionally, the vehicle system controller 20 communicates to the brake controller 34 any torque demand input by the vehicle operator through the accelerator pedal 24. In response, the brake controller 34 modifies the braking signal to reduce the independent braking as the vehicle operator's torque demand becomes greater than the torque provided to the wheel 16 by the engine 12 operating at the first idle speed. The brake controller 34 ceases the independent braking signal when the operator's acceleration torque demand exceeds the torque provided to the wheel 16 by the engine 12 operating at the second idle speed. The brake controller 34 further ceases the independent braking when the idle speed of the engine 12 is reduced from the second idle speed to the first idle speed.

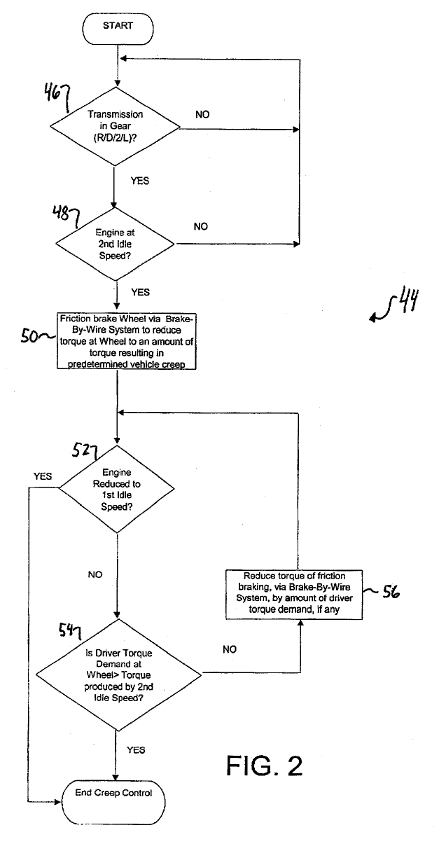

FIG. 2 is a flow diagram of a method 44 for controlling high idle creep by brake-by-wire braking according to the present invention. The method 44 can include the step 46 of determining whether the engine 12 is initially torsionally engaging the wheel 16 from a nonengaged state; that is, whether the driver has placed the transmission in gear to provide torque to the wheel 16. This event would occur if the vehicle operator has placed the transmission in reverse, drive, second, or low gear of an automatic transmission. The determination of this step can be accomplished by the vehicle system controller 20.

If the vehicle operator has placed the transmission in gear, the method 44 can include the next step 48 of determining whether the engine 12 is at the second idle speed. This determination can be accomplished by the vehicle system controller 20.

If the engine 12 is operating at the second idle speed, the method 44 can next include the step 50 of friction braking the wheel 16 via the brake-by-wire system 30. This step can be accomplished by the vehicle system controller 20 in communication with the brake controller 34. The brake controller 34 will brake the wheel 16 to reduce the amount of torque at the wheel 16 produced by the engine 12 at the second idle speed, in order to achieve a predetermined creep speed of the vehicle 10 such as, for example, five miles per hour.

In addition to achieving a predetermined creep speed for the vehicle 10, the method 44 can also include steps to take into account dynamic driving events. Specifically, the method 44 can include the further step 52 of determining whether the operating speed of the engine 12 has been reduced to the first idle speed. This step can be accomplished by vehicle system controller 20. If the speed of the engine 12 has been so reduced, then the method 44 can cease the creep control through the brake-by-wire system 30.

If the engine 12 continues to operate at the second idle speed, then the method 44 can include the next step 54 of determining torque demand of the vehicle operator at the wheel 16. This determination can be accomplished by the vehicle system controller 20, based upon the signal 26 indicative of the position of the accelerator pedal 24. If the vehicle operator's torque demand is greater than the torque produced by the engine 12 operating at the second idle speed, then the method 44 can end creep control through the brake-by-wire system 30.

If the vehicle operator's torque demand is not greater than the torque produced by the engine 12 operating at the second idle speed, then the method 44 can include the step 56 of reducing the torque of friction braking, via the brake-by-wire system 30, by an amount equal to the torque demand of the vehicle operator, as determined by the position of the accelerator pedal 24. The method 44 will then continue to monitor and modify, if necessary, the friction brake torque until either the engine returns to the first idle speed or the driver torque demand exceeds the torque produced by the second idle speed.

While the invention has been particularly shown and described with reference to the preferred embodiments thereof, it is well understood by those skilled in the art that various changes and modifications can be made to the inventive method without departing from the spirit and scope of the invention.

1. A method of controlling creep in a vehicle, said vehicle having a brake-by-wire system for braking a wheel independent of a braking action demanded by a vehicle operator, and said vehicle having an internal combustion engine for powering said wheel and for powering a load, wherein said engine is operable at a first idle speed and a second faster idle speed, said method comprising:
determining whether said engine is operating at said second idle speed; and friction braking said wheel through said brake-by-wire system to offset additional torque provided to said wheel by said engine at said second idle speed.

2. The method according to claim 1, further comprising the steps of determining a vehicle operator's torque demand at said wheel, and modifying said friction braking based on said vehicle operator's torque demand.

3. The method according to claim 2, further comprising the step of ceasing said friction braking when said vehicle operator torque demand equals a predetermined level.

4. The method according to claim 1, wherein said internal combustion engine is initially torsionally engaging said wheel from a nonengaged state.

5. The method according to claim 1, wherein said second idle speed is a function of said engine's temperature.

6. The method according to claim 1, wherein said vehicle engine has an emissions control system, and wherein said second idle speed is a function of a temperature of said emission control system.

7. The method according to claim 1, wherein said load comprises charging a battery of said vehicle.

8. The method according to claim 7, wherein said second idle speed is a function of said battery charge state.

9. The method according to claim 1, wherein said load is a power steering pump.

10. The method according to claim 9, wherein said second idle speed is a function of vehicle velocity.

11. The method according to claim 1, wherein said load is an air conditioning compressor.

12. The method according to claim 1, wherein said brake-by-wire system comprises an electric brake.

13. The method according to claim 1, wherein said brake-by-wire system comprises an electro-hydraulic brake system.

14. A method of controlling creep in a vehicle, said vehicle having a brake-by-wire system for braking a wheel independent of a braking action demanded by a vehicle operator, and said vehicle having an internal combustion engine for powering said wheel and for powering a load, wherein said engine is operable at a first idle speed and a second faster idle speed, said method comprising:
determining whether said engine is powering said wheel;
determining whether said engine is operating at said second idle speed; and
friction braking said wheel through said brake-by-wire system to offset additional torque provided to said wheel by said engine at said second idle speed.

15. The method according to claim 14, further comprising the step of ceasing friction braking of said wheel through said brake-by-wire system when said engine speed is reduced from said second idle speed to said first idle speed.

16. The method according to claim 14, further comprising the steps of determining a vehicle operator's torque demand at said wheel, and ceasing friction braking of said wheel through said brake-by-wire system when said torque demand is greater than the torque produced by said second idle speed.

17. The method according to claim 14, further comprising the steps of determining a vehicle operator's torque demand at said wheel, and reducing the amount of friction braking of said wheel through said brake-by-wire system.

18. A method of controlling creep in a hybrid electric vehicle (HEV), said HEV having an internal combustion engine, a generator, a battery, and a brake-by-wire system, said engine for powering a wheel and for powering said generator, said generator for charging a battery, and said brake-by-wire system for braking said wheel independent of a braking action demanded by a vehicle operator, and wherein said engine is operable at a first idle speed and a second faster idle speed, said method comprising:
determining whether said engine is powering said wheel;
determining whether said engine is operating at said second idle speed; and
friction braking said wheel through said brake-by-wire system to offset additional torque provided to said wheel by said engine at said second idle speed.

19. The method according to claim 18, further comprising the step of ceasing friction braking of said wheel through said brake-by-wire system when said engine speed is reduced from said second idle speed to said first idle speed.

20. The method according to claim 18, further comprising the steps of determining a vehicle operator's torque demand at said wheel, and ceasing friction braking of said wheel through said brake-by-wire system when said torque demand is greater than the torque produced by said second idle speed.

21. The method according to claim 18, further comprising the steps of determining a vehicle operator's torque demand at said wheel, and reducing the amount of friction braking of said wheel through said brake-by-wire system.

22. The method according to claim 18, wherein said second idle speed is a function of a charge state of said battery.

23. A creep control system for a vehicle, said vehicle having an internal combustion engine for powering a wheel and for powering a load, wherein said engine is operable at a first idle speed and a second faster idle speed, said creep control system comprising:
a braking device for braking said wheel in response to a braking signal; and
a controller generating a braking signal to offset additional power provided to said wheel by said engine at said second idle speed.

24. The creep control system of claim 23, wherein said controller further determines whether said engine is providing torque to said wheel.

25. The creep control system of claim 23, wherein said controller further determines a vehicle operator's torque demand at said wheel, and generates a braking signal to cease braking when said torque demand is greater than torque produced by said second idle speed to said wheel.

26. An automotive vehicle comprising:
an internal combustion engine for powering a wheel and a load, said engine operable at a first idle speed and a second faster idle speed;
a brake-by-wire system for braking said wheel independent of a braking action demanded by a vehicle operator; and
a controller generating a braking signal to offset additional power provided to said wheel by said engine at said second idle speed.

27. The vehicle of claim 26, wherein said controller further determines whether said engine is providing torque to said wheel.

28. The vehicle of claim 26, wherein said controller further determines a vehicle operator's torque demand at said wheel, and generates a braking signal to cease braking when said torque demand is greater than torque produced by said second idle speed to said wheel.

29. The vehicle of claim 26, wherein said second idle speed is a function of said engine's temperature.

30. The vehicle of claim 26, further comprising an emissions control system and wherein said second idle speed is a function a temperature of said emission control system.

31. The vehicle of claim 26, further comprising a battery and wherein said load comprises charging said battery.

32. The vehicle of claim 31, wherein said second idle speed is a function of said battery charge state.

33. The vehicle of claim 26, wherein said load comprises a power steering pump.

34. The vehicle of claim 33, wherein said second idle speed is a function of vehicle velocity.

35. The vehicle of claim 26, wherein said load comprises an air conditioning compressor.

36. The vehicle of claim 26, wherein said braking device comprises an electric brake.

37. The vehicle of claim 26, wherein said braking device comprises an electro-hydraulic brake.

38. A hybrid electric vehicle (HEV) having an internal combustion engine operable at a first idle speed and a second faster idle speed, and a generator powered by said engine, and a battery chargeable by said generator, said HEV comprising:
a wheel powered by said engine;
a brake-by-wire system for braking said wheel independent of a braking action demanded by a vehicle operator; and,
a controller for generating a braking signal to offset additional power provided to said wheel by said engine at said second idle speed.

39. The HEV according to claim 38, wherein said controller further generates a signal to cease friction braking of said wheel through said brake-by-wire system when said engine speed is reduced from said second idle speed to said first idle speed.

40. The HEV of claim 38, wherein said controller further determines a vehicle operator's torque demand at said wheel, and generates a signal to cease friction braking of said wheel through said brake-by-wire system when said torque demand is greater than the torque produced by said second idle speed.

41. The HEV of claim 38, wherein said controller further determines a vehicle operator's torque demand at said wheel, and generates a signal to reduce the amount of friction braking of said wheel through said brake-by-wire system.

42. The HEV of claim 38, wherein said second idle speed is a function of a charge state of said battery.
